(19) United States
(12) Patent Application Publication
(10) Pub. No.: US 2025/0287463 A1
(43) Pub. Date: Sep. 11, 2025

(54) QUALITY OF EXPERIENCE CONFIGURATION FOR A MULTICAST OR BROADCAST SERVICE

(71) Applicant: QUALCOMM Incorporated, San Diego, CA (US)

(72) Inventors: Jianhua LIU, Beijing (CN); Shankar KRISHNAN, Poway, CA (US); Rajeev KUMAR, San Diego, CA (US); Ozcan OZTURK, San Diego, CA (US); Xipeng ZHU, San Diego, CA (US)

(21) Appl. No.: 18/863,800

(22) PCT Filed: Aug. 5, 2022
(86) PCT No.: PCT/CN2022/110441

§ 371 Date: Nov. 7, 2024

(51) Int. Cl. H04W 76/40; H04L 43/0817

(52) U.S. Cl. CPC H04W 76/40; H04L 43/0817

(57) ABSTRACT

Various aspects of the present disclosure generally relate to wireless communication. In some aspects, a user equipment (UE) may receive a quality of experience (QoE) configuration, wherein the QoE configuration is associated with a multicast or broadcast service (MBS). The UE may collect at least one QoE measurement associated with the MBS based at least in part on the QoE configuration. Numerous other aspects are described.

### FIELD OF THE DISCLOSURE

Aspects of the present disclosure generally relate to wireless communication and to techniques and apparatuses for a quality of experience configuration for a multicast or broadcast service.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single- carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a quality of experience (QoE) configuration, wherein the QoE configuration is associated with a multicast or broadcast service (MBS). The method may include collecting at least one QoE measurement associated with the MBS based at least in part on the QoE configuration.

Some aspects described herein relate to a method of wireless communication performed by a network node. The method may include transmitting, to a UE, a QoE configuration, wherein the QoE configuration is associated with an MBS. The method may include receiving, from the UE, at least one QoE measurement report based at least in part on the QoE configuration.

Some aspects described herein relate to an apparatus for wireless communication at a UE. The apparatus may include a memory and one or more processors coupled to the memory. The one or more processors may be configured to receive a QoE configuration, wherein the QoE configuration is associated with an MBS. The one or more processors may be configured to collect at least one QoE measurement associated with the MBS based at least in part on the QoE configuration.

Some aspects described herein relate to an apparatus for wireless communication at a network node. The apparatus may include a memory and one or more processors coupled to the memory. The one or more processors may be configured to transmit, to a UE, a QoE configuration, wherein the QoE configuration is associated with an MBS. The one or more processors may be configured to receive, from the UE, at least one QoE measurement report based at least in part on the QoE configuration.

Some aspects described herein relate to a non-transitory computer-readable medium that stores a set of instructions for wireless communication by a UE. The set of instructions, when executed by one or more processors of the UE, may cause the UE to receive a QoE configuration, wherein the QoE configuration is associated with an MBS. The set of instructions, when executed by one or more processors of the UE, may cause the UE to collect at least one QoE measurement associated with the MBS based at least in part on the QoE configuration.

Some aspects described herein relate to a non-transitory computer-readable medium that stores a set of instructions for wireless communication by a network node. The set of instructions, when executed by one or more processors of the network node, may cause the network node to transmit, to a UE, a QoE configuration, wherein the QoE configuration is associated with an MBS. The set of instructions, when executed by one or more processors of the network node, may cause the network node to receive, from the UE, at least one QoE measurement report based at least in part on the QoE configuration.

Some aspects described herein relate to an apparatus for wireless communication. The apparatus may include means for receiving a QoE configuration, wherein the QoE configuration is associated with an MBS. The apparatus may include means for collecting at least one QoE measurement associated with the MBS based at least in part on the QoE configuration.

Some aspects described herein relate to an apparatus for wireless communication. The apparatus may include means for transmitting, to a UE, a QoE configuration, wherein the QoE configuration is associated with an MBS. The apparatus may include means for receiving, from the UE, at least one QoE measurement report based at least in part on the QoE configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4B are diagrams illustrating an example of a quality of experience (QoE) configuration and reporting procedure, in accordance with the present disclosure.

FIGS. 5A-5B are diagrams of an example associated with a QoE configuration for an MBS, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

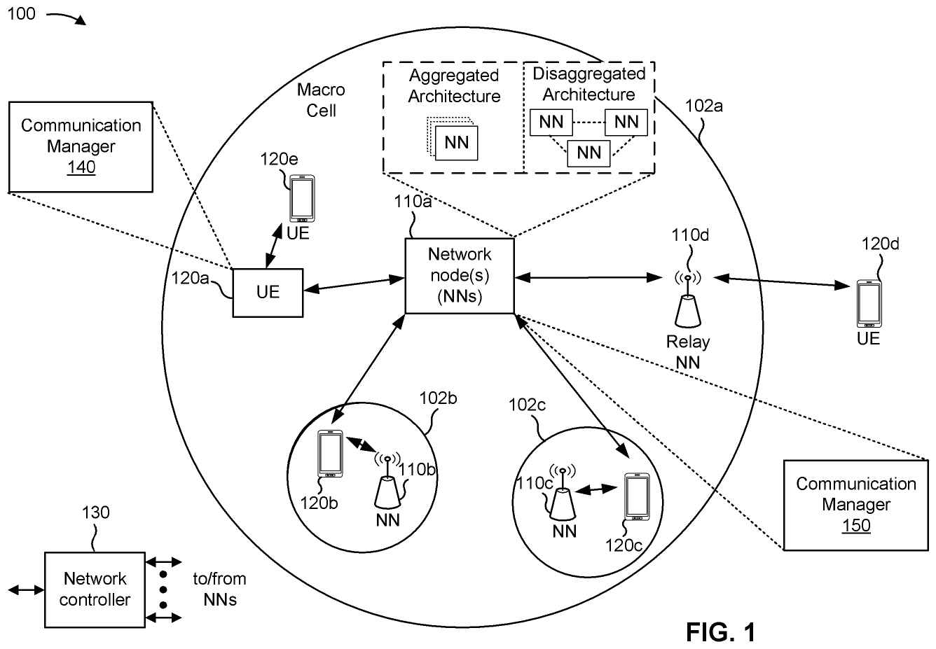

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a quality of experience (QoE) configuration, wherein the QoE configuration is associated with a multicast or broadcast service (MBS); and collect at least one QoE measurement associated with the MBS based at least in part on the QoE configuration. Additionally, or alternatively, the communication manager 140 may perform one or more other operations described herein.

In some aspects, the network node 110 may include a communication manager 150. As described in more detail elsewhere herein, the communication manager 150 may transmit, to a UE (e.g., UE 120), a QoE configuration, wherein the QoE configuration is associated with an MBS; and receive, from the UE, at least one QoE measurement report based at least in part on the QoE configuration. Additionally, or alternatively, the communication manager 150 may perform one or more other operations described herein.

As indicated above, FIG. 1 is provided as an example. Other examples may differ from what is described with regard to FIG. 1.

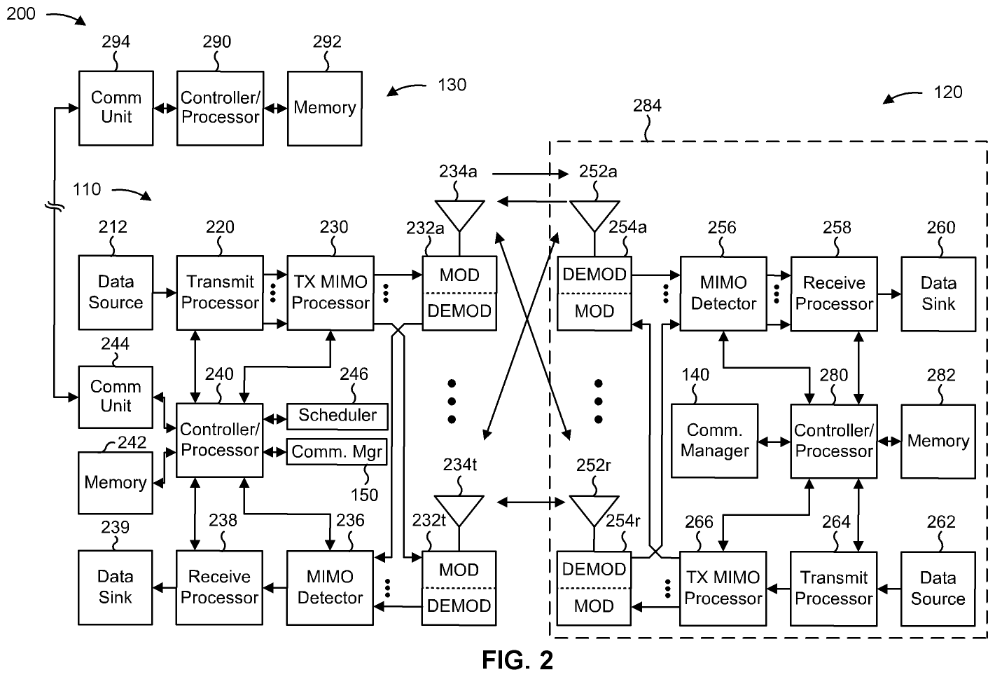

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

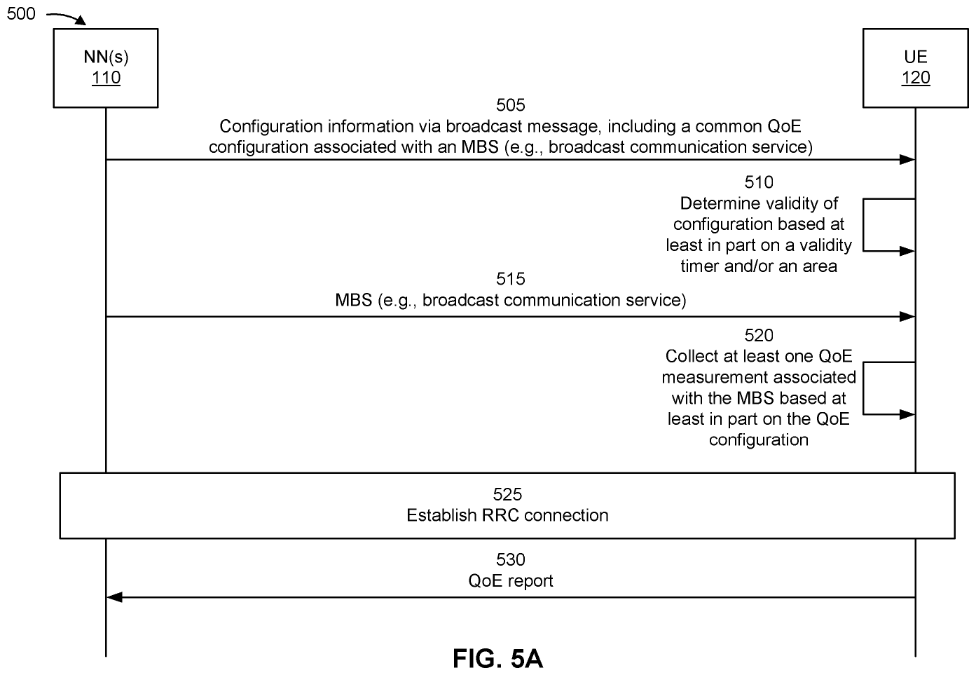

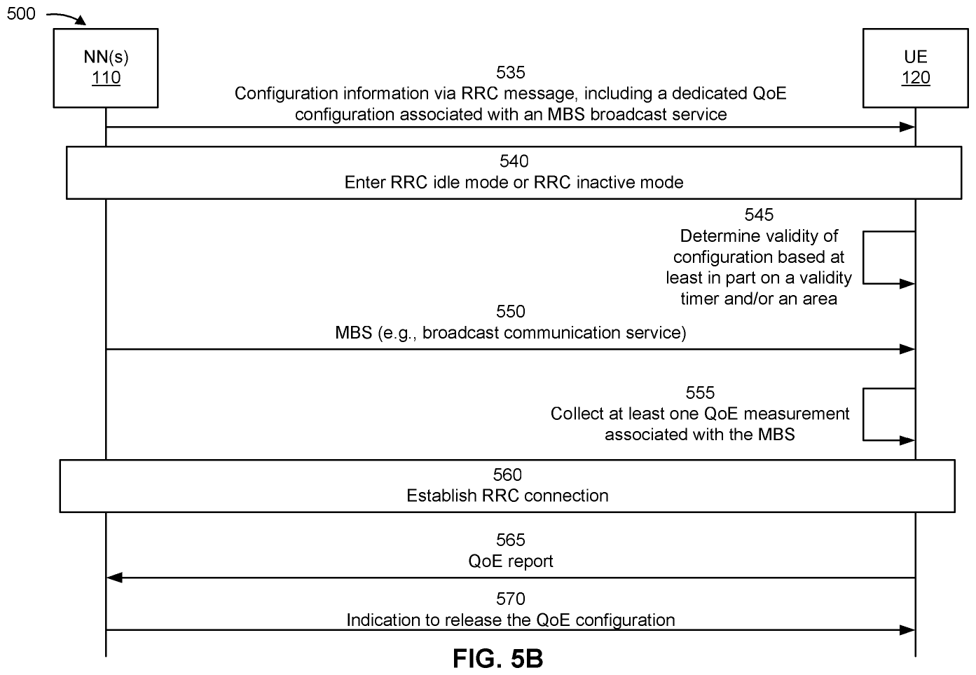

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-9).

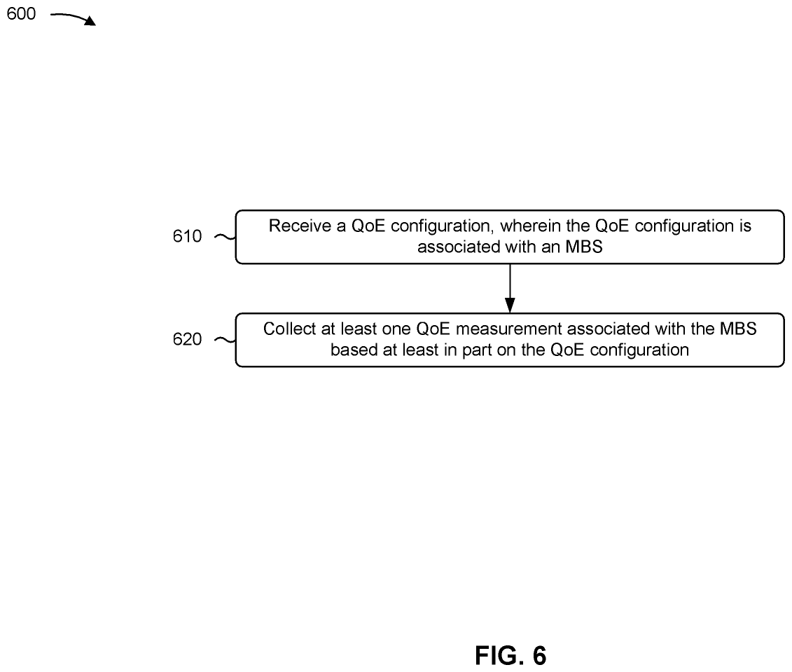

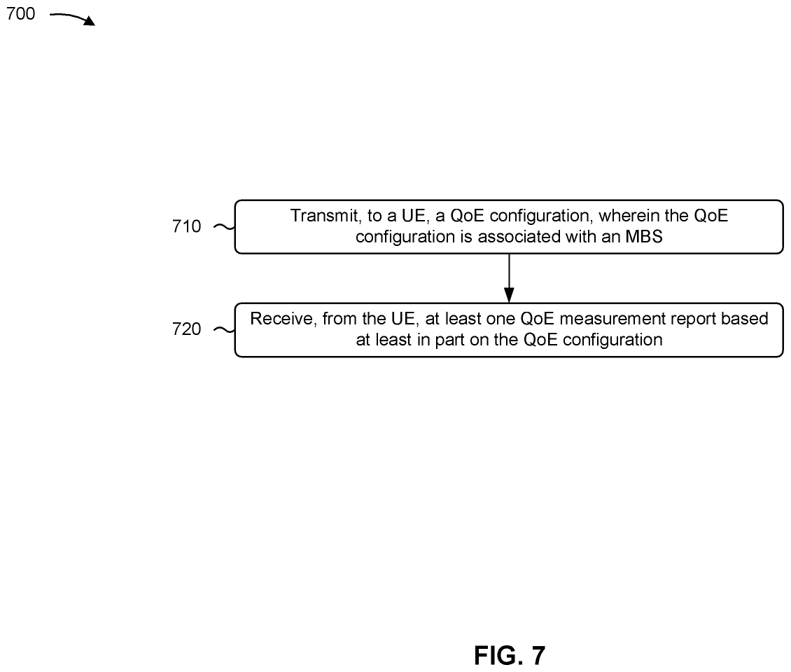

The controller/processor 240 of the network node 110, the controller/processor 280 of the UE 120, and/or any other component(s) of FIG. 2 may perform one or more techniques associated with a QoE configuration for an MBS, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving a QoE configuration, wherein the QoE configuration is associated with an MBS; and/or means for collecting at least one QoE measurement associated with the MBS based at least in part on the QoE configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to UE 120, a QoE configuration, wherein the QoE configuration is associated with an MBS; and/or means for receiving, from the UE, at least one QoE measurement report based at least in part on the QoE configuration. In some aspects, the means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

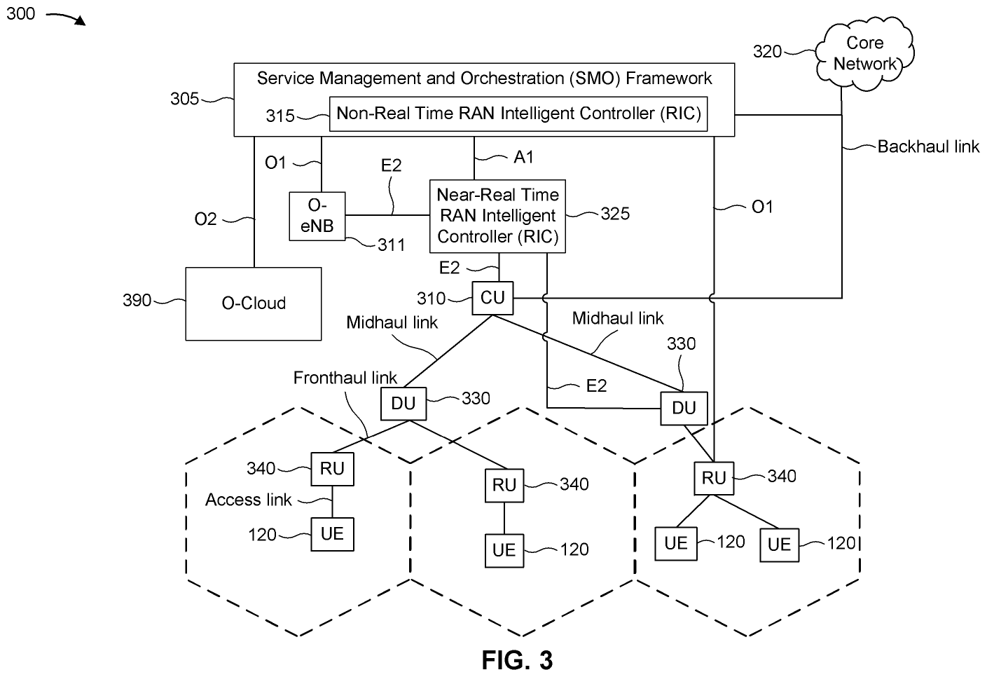

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an 01 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an 01 interface) or via creation of RAN management policies (such as Al interface policies).

As indicated above, FIG. 3 is provided as an example. Other examples may differ from what is described with regard to FIG. 3.

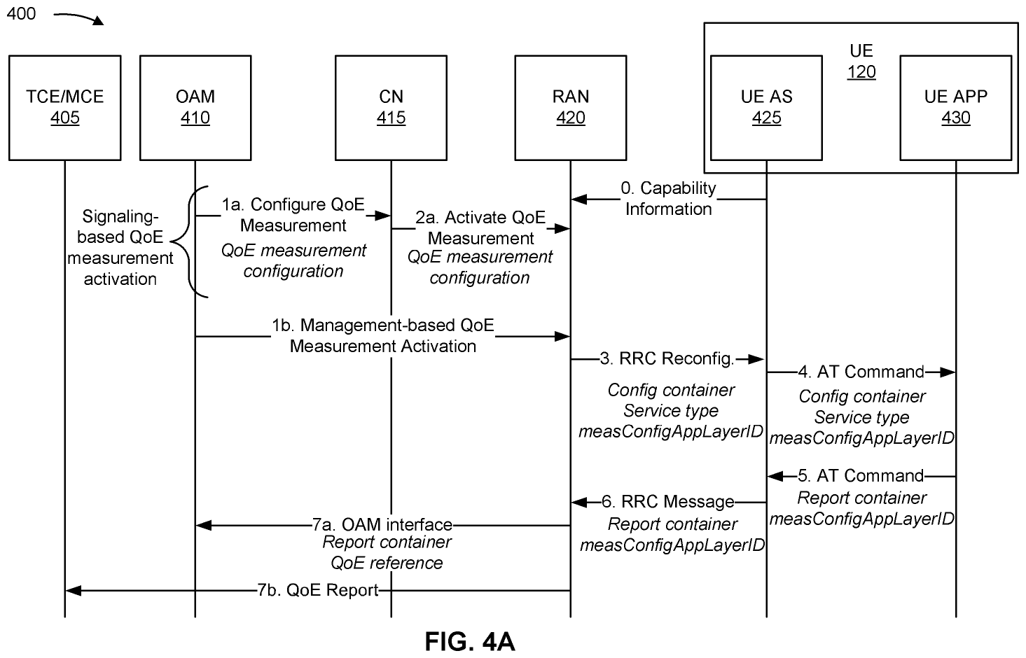

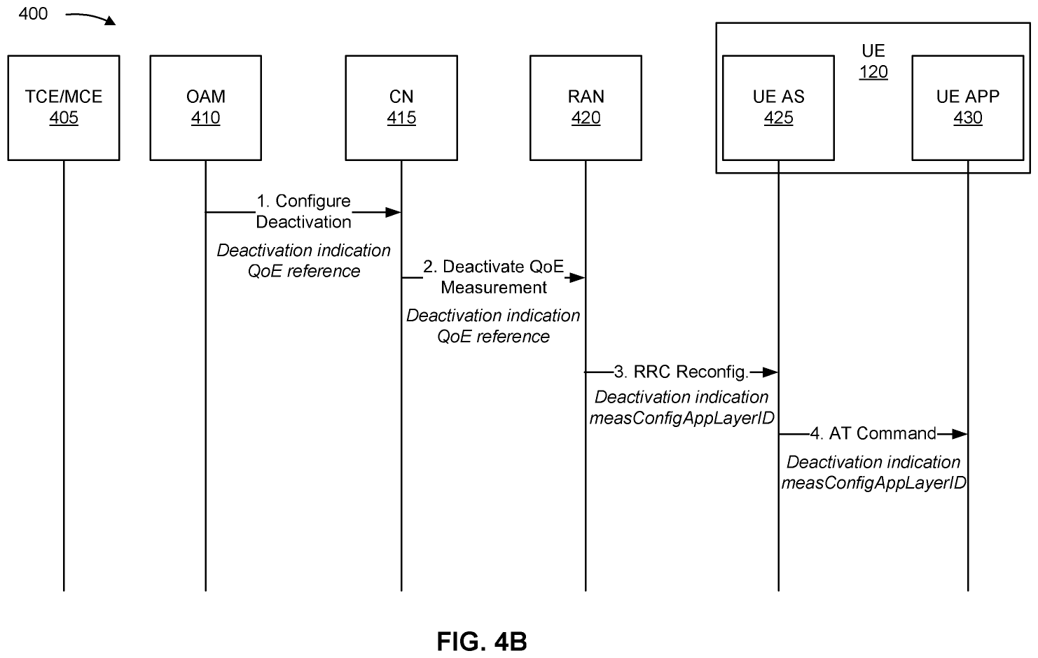

FIGS. 4A-4B are diagrams illustrating an example 400 of a QoE configuration and reporting procedure, in accordance with the present disclosure. As shown in FIGS. 4A-4B, various network entities and devices, and layers within such devices, may communicate with one another over a wireless network (e.g., wireless network 100) or the like. For example, a trace collection entity (TCE)/measurement collection entity (MCE) entity (e.g., TCE/MCE 405), an operations, administration, and management (OAM) entity (e.g., OAM 410), a core network (CN) entity (e.g., CN 415), a RAN entity (e.g., RAN 420) (which, in some aspects, may be an NG-RAN entity such as a network node 110 or a similar entity), a UE access stratum (AS) layer or entity (e.g., US AS 425), and/or a UE application (APP) layer or entity (e.g., UE APP 430) may communicate with one another. In some aspects, the UE AS 425 and the UE APP 430 may be associated with a UE 120.

FIG. 4A shows an example of a QoE measurement collection (QMC) activation and reporting procedure. As shown as step 0, the UE AS 425 may report UE 120 capability information to the RAN 420. For example, the capability information may be reported during an initial access procedure, and may include information regarding types of QoE metrics the UE 120 is capable of measuring, or the like. Then, QMC activation may be achieved either via a signaling-based QoE activation procedure or a management-based QoE activation procedure. As shown as step 1a, in a signaling-based NR QoE activation procedure, the OAM 410 may configure the CN 415 with QoE measurement information, sometimes referred to as a QoE measurement configuration or simply a QoE configuration. As shown as step 2a, in the signaling-based NR QoE activation procedure, the CN 415 may activate a QoE measurement procedure by forwarding the QoE measurement configuration to the RAN 420. Alternatively, in a management-based activation procedure, as shown as step 1b, the OAM 410 may activate the QoE measurement procedure by forwarding the QoE measurement configuration directly to the RAN 420. Put another way, in the signaling-based NR QoE activation procedure, the CN 415 may initiate the activation of QoE measurement, as configured by the OAM 410, while in the management-based NR QoE activation procedure, the RAN 420 may initiate the activation of QoE measurement, as configured by the OAM 410. In some aspects, the OAM 410 may configure and/or activate multiple simultaneous QoE measurements. In some aspects, the QoE measurement configuration may include a QMC configuration container (e.g., an extensible markup language (XML) file) associated with the QoE configuration, an indication of a QoE reference associated with the QoE configuration, an indication of a service type associated with the QoE configuration, an indication of a multicast coordination entity internet protocol address associated with the QoE configuration, an indication of an area scope associated with the QoE configuration, an indication of a slice scope associated with the QoE configuration, an indication of minimization of drive tests alignment information associated with the QoE configuration, and/or an indication of available RAN visible QoE metrics associated with the QoE configuration, among other information.

As shown by step 3, the RAN 420 may transmit an RRC reconfiguration message (sometimes referred to as an RRCReconfiguration message) to the UE 120 (and, more particularly, to the UE AS 425) that includes the QoE measurement configuration. In some cases, the RRC reconfiguration message may include a QMC configuration container (e.g., an XML file) associated with the QoE configuration, an indication of a measurement configuration identifier associated with the QoE configuration (sometimes referred to as measConfigAppLayerID), and/or an indication of a service type associated with the QoE configuration, among other information. In this regard, the RAN 420 may maintain a mapping between the measurement configuration identifier associated with the QoE configuration (e.g., measConfigAppLayerID) and the QoE reference indicated by the QoE measurement activation message described above in connection with reference steps 2a and 1b.

As shown as step 4, the UE AS 425 may transmit an attention (AT) command or the like to the UE APP 430 that includes the QoE measurement configuration. The UE APP 430 may make one or more QoE measurements based at least in part on the QoE measurement configuration, and, as shown as step 5, the UE APP 430 may transmit an AT command or the like to the UE AS 425 that includes a QoE report including the one or more QoE measurements and/or one or more QoE metrics. More particularly, the UE APP 430 may transmit a report container to the UE AS 425 indicating the one or more QoE measurements and/or the measurement configuration identifier associated with the QoE configuration (e.g., measConfigAppLayerID).

As shown as step 6, the UE AS 425 may transmit an RRC message or the like to the RAN 420 that includes the QoE report. In some cases, the application layer measurements transmitted from the UE AS 425 to the RAN 420 may be encapsulated in a transparent container in a measurement report RRC message (sometimes referred to as a measurementReportAppLayer RRC message), which may be transmitted over a signaling radio bearer (SRB), such as SRB4. Moreover, segmentation of the measurement report RRC message (e.g., the measurementReportAppLayer RRC message) may be enabled by the RAN 420 to permit transmission of application layer measurement reports which exceed the maximum PDCP service data unit (SDU) size. Additionally, in some instances, the RRC message may indicate the measurement configuration identifier associated with the QoE configuration (e.g., measConfigAppLayerID), which may be used to identify one application layer measurement configuration and report between the RAN 420 and the AS 425. And as shown as steps 7a and 7b, the RAN 420 may transmit the QoE report to the OAM 410 and/or the TCE/MCE 405, respectively. In some cases, the QoE report may be associated with a report container and/or may indicate a QoE reference corresponding to the QoE measurement configuration and/or QoE report.

FIG. 4B shows an example of a QMC deactivation and/or release procedure. In some cases, the OAM 410 or a similar entity may trigger a UE 120 to deactivate a list of QoE measurement collection jobs. Additionally, or alternatively, a network node 110 (e.g., RAN 420) may release one or more application layer measurement configurations from the UE in an RRC reconfiguration message (e.g., a RRCReconfiguration message). Moreover, in some cases, if a UE 120 enters an RRC idle mode, the UE 120 may release all QoE measurement configurations.

For example, as shown as step 1 in FIG. 4B, the OAM 410 may transmit, to the CN 415, a configure deactivation message, which may include a deactivation indication associated with a QoE measurement configuration and/or a QoE reference associated with the QoE measurement configuration to be deactivated, among other information. As shown by step 2, the CN 415 may transmit, to the RAN 420, a deactivate QoE measurement message, which may include the deactivation indication associated with the QoE measurement configuration and/or the QoE reference associated with the QoE measurement configuration to be deactivated, among other information. In some other aspects, such as in a management-based deactivation procedure, the OAM 410 may transmit a deactivate QoE measurement message directly to the RAN 420. As shown by step 3, the RAN 420 may transmit, to the UE AS 425, an RRC reconfiguration message (e.g., an RRCReconfiguration message), which may include the deactivation indication and an indication of a measurement configuration identifier (e.g., measConfigAppLayerID) associated with the QoE configuration to be deactivated. As described above, the RAN 420 may maintain a mapping between QoE references and measurement configuration identifiers, such that when the RAN 420 receives the deactivate QoE measurement message at step 2, the RAN 420 may map the QoE reference to the corresponding measurement configuration identifier (e.g., measConfigAppLayerID) for inclusion in the RRC reconfiguration message. Finally, as shown by step 4, the AS 425 may indicate to the application layer to release the QoE measurement configuration, such as by transmitting, to the UE APP 430, an AT command or the like. The AT command may include the deactivation indication and the indication of the measurement configuration identifier (e.g., measConfigAppLayerID) associated with the QoE measurement configuration to be deactivated. Upon receipt of the release command (e.g., the AT command shown in connection with step 4), the UE APP 430 may release the QoE measurement configuration, and thus cease to collect QoE measurements associated with the QoE measurement configuration. Moreover, as described above, if the UE 120 enters an RRC idle mode, the UE 120 may autonomously release all QoE measurement configurations.

In some cases, a UE 120 may receive an MBS, such as a broadcast communication service. For a broadcast communication service, the same service and the same specific content data are provided simultaneously (e.g., broadcast) to multiple UEs 120 within a geographic area. Put another way, all UEs 120 in a broadcast service area are authorized to receive the data associated with a broadcast communication service. In some cases, a broadcast communication service is delivered to a UE 120 using a broadcast session via a broadcast traffic channel (sometimes referred to as a multicast traffic channel (MTCH)), and a UE 120 may receive a broadcast service in an RRC idle mode (sometimes referred to as RRC_IDLE), an RRC inactive mode (sometimes referred to as RRC_INACTIVE), or an RRC connected mode (sometimes referred to as RRC_CONNECTED). In some instances, a UE 120 may receive an MBS configuration for a broadcast session (which may include parameters needed for MTCH reception) via a broadcast control channel (sometimes referred to as a multicast control channel (MCCH)) while in an RRC idle mode, an RRC inactive mode, or an RRC connected mode. Moreover, in some cases, a UE 120 may receive parameters needed for reception of the MCCH via a system information message.

In some instances, it may be beneficial for a UE 120 to collect QoE measurements associated with a broadcast communication service, such as when the UE 120 is receiving a broadcast communication service while in an RRC idle mode. However, as described above in connection with FIG. 4A, under legacy procedures there is no QoE measurement configuration mechanism for idle mode UEs 120. More particularly, a UE 120 must be in an RRC connected mode to receive a QoE measurement configuration, such as via an RRC reconfiguration message, and when a UE 120 enters an idle mode, the UE 120 will release all QoE measurement configurations. Thus, in order to configure an idle mode UE 120 for QMC, the UE 120 must first enter a connected mode and then receive an RRC reconfiguration message, or the like. The UE 120 may then collect QoE measurements while in a connected mode, but will subsequently release all QoE measurement configurations if the UE 120 reenters the idle mode, as described. This increases a number of mode transitions performed by a UE 120, thus increasing signaling overhead and power consumption, or else require that a network node 110 and UE 120 forgo QMC for broadcast communication services, leading to overall inefficient usage of network resources.

Some techniques and apparatuses described herein enable QMC for a UE 120 in an idle mode, such as for an MBS (e.g., a broadcast communication service) being received by the UE 120 while in an idle mode. In some aspects, a network node 110 may transmit a QoE measurement configuration to a UE 120 via a broadcast message, and the UE 120 may collect one or more QoE measurements based at least in part on the QoE measurement configuration, such as when the UE 120 is receiving the broadcast communication service while in an idle mode. In some other aspects, a network node 110 may transmit a QoE measurement configuration to a UE 120 via a dedicated QoE measurement configuration message associated with a broadcast communication service, such as via an RRC message received when the UE 120 is in a connected mode, and the UE 120 may maintain the QoE measurement configuration even if the UE 120 enters an idle mode, such that the UE 120 may collect one or more QoE measurements associated with the broadcast communication service based at least in part on the QoE measurement configuration. As a result, network devices may conserve computing, power, network, and/or communication resources that may have otherwise been associated with a UE 120 transitioning to a connected mode to receive QoE measurement configurations and collect QoE measurements, and one or more network devices may beneficially utilize QoE measurements associated with broadcast communication services or other services delivered to a UE 120 in an idle mode, resulting in efficient use of network resources.

As indicated above, FIGS. 4A-4B are provided as examples. Other examples may differ from what is described with respect to FIGS. 4A-4B.

FIGS. 5A-5B are diagrams of an example 500 associated with a QoE configuration for an MBS, in accordance with the present disclosure. As shown in FIGS. 5A-5B, one or more network nodes 110 (shown as “NN(s) 110”) may communicate with a UE 120. In some aspects, the one or more network nodes 110 and the UE 120 may be part of a wireless network (e.g., wireless network 100). The UE 120 and the one or more network nodes 110 may have established a wireless connection prior to operations shown in FIG. 5A-5B. As is described in more detail below, in some aspects, the UE 120 may be in an RRC idle mode or an RRC inactive mode during at least some of the communications shown in FIGS. 5A-5B. For example, in some aspects, the UE 120 may receive one or more MBSs, such as a broadcast communication service, from the one or more network nodes 110 while in an RRC idle mode or an RRC inactive mode.

FIG. 5A shows an example associated with the UE 120 receiving a common QoE configuration via a broadcast message. As shown by reference number 505, the one or more network nodes 110 may transmit, and the UE 120 may receive, configuration information. In some aspects, the UE 120 may receive the configuration information via one or more of RRC signaling, one or more MAC control elements (MAC-CEs), downlink control information (DCI), and/or one or more system information communications transmitted via a broadcast channel, among other examples. In some aspects, the configuration information may include an indication of one or more configuration parameters (e.g., already known to the UE 120 and/or previously indicated by the one or more network nodes 110 or other network devices) for selection by the UE 120, and/or explicit configuration information for the UE 120 to use to configure the UE 120, among other examples.

In some aspects, the configuration information may include one or more QoE configurations associated with an MBS, such as a broadcast communication service. Moreover, in the aspects depicted in FIG. 5A, the QoE configuration may be a common QoE configuration received via a broadcast message. For example, in some aspects, the common QoE configuration may be received by the UE 120 via a broadcast message. In some aspects, the UE 120 may receive the broadcast communication including the QoE configuration while the UE 120 is in an RRC idle mode or an RRC inactive mode, as described in more detail below. However, aspects of the disclosure are not so limited. In some other aspects, the QoE configuration may be a dedicated QoE configuration received via an RRC message or the like while the UE 120 is in an RRC connected mode, which is described in more detail below in connection with FIG. 5B.

In some aspects, the common QoE configuration may indicate certain parameters associated with one or more QMCs and/or one or more MBSs (e.g., one or more broadcast communication services) received by the UE 120, such as one or more MBSs received by the UE 120 when the UE 120 is in an RRC idle mode or an RRC inactive mode. For example, the common QoE configuration may indicate at least one of a QoE configuration container associated with the common QoE configuration, a service type associated with the common QoE configuration (e.g., a particular MBS associated with the QoE configuration), or an identifier associated with the common QoE configuration (e.g., a QoE reference associated with the QoE configuration), among other information. In some aspects, the common QoE configuration may indicate a temporary mobile group identity (TMGI) associated with the MBS being received by the UE 120 and/or associated with the common QoE configuration.

In some aspects, the common QoE configuration may be received by the UE 120 via an RRC message transmitted via a broadcast control channel. For example, the common QoE configuration may be received by the UE 120, from the one or more network nodes 110, via a broadcast message associated with an RRC message transmitted over the MCCH. In some other aspects, the UE 120 may receive the common QoE configuration via a system information message transmitted by the one or more network nodes 110. The UE 120 may configure itself based at least in part on the configuration information. In some aspects, the UE 120 may be configured to perform one or more operations described herein based at least in part on the configuration information.

As shown by reference number 510, in some aspects, the UE 120 may determine a validity of the QoE configuration based at least in part on whether the UE 120 is already configured to collect one or more measurements associated with the MBS (e.g., whether the UE 120 already has a valid QoE configuration associated with the MBS), whether a validity timer associated with the QoE configuration has expired, whether the UE 120 is operating in a valid area associated with the QoE configuration, or the like. For example, in some aspects, the UE 120 may transmit the common QoE configuration from an access stratum layer associated with the UE 120 (e.g., the UE AS 425) to an application layer associated with the UE 120 (e.g., the UE APP 430), such as described in connection with the AT command shown as step 4 in FIG. 4A. In some aspects, transmitting the common QoE configuration from the access stratum layer to the application layer may be based at least in part on the UE 120 having no valid configuration associated with the common QoE configuration. Additionally, or alternatively, transmitting the common QoE configuration from the access stratum layer to the application layer may be based at least in part on the UE 120 receiving the MBS associated with the common QoE configuration. More particularly, if the MBS associated with the common QoE configuration is a service that the UE 120 is not currently receiving and will not receive, the UE 120 may forgo transmitting the common QoE configuration from the access stratum layer to the application layer (e.g., the UE 120 may not transmit an AT command including the common QoE configuration from the access stratum layer to the application layer). However, if the MBS associated with the common QoE configuration is a service that the UE 120 is currently receiving and/or is interested in receiving, the UE 120 may then transmit the common QoE configuration from the access stratum layer to the application layer, such as via an AT command, as described. In some aspects, transmitting the common QoE configuration from the access stratum layer to the application layer may include transmitting an indication of an identifier associated with the QoE configuration and/or the associated MBS, such as an indication of a TMGI associated with the MBS.

In some aspects, the common QoE configuration may be associated with a validity timer, which is associated with a period of time during which the QoE configuration is valid, and after expiration of which the QoE configuration is no longer valid. Accordingly, in aspects in which the QoE configuration is associated with a validity timer, the operations described in connection with reference number 510 may include the UE 120 starting the validity timer associated with the common QoE configuration. Additionally, or alternatively, in the operations shown by reference number 510, the UE 120 may determine that the common QoE configuration is invalid based at least in part on an expiration of the validity timer.

Additionally, or alternatively, the common QoE configuration may be associated with a validity area. In some aspects, the validity area may be a geographic area in which the QoE configuration is valid. In some other aspects, the validity area may be associated with a cell list, a tracking area list, a frequency list, or a similar list. Accordingly, in aspects in which the QoE configuration is associated with a validity area, the operations shown in connection with reference number 510 may include the UE 120 determining whether the UE 120 is within the validity area. If the UE 120 is within the validity area, the UE 120 may apply the QoE configuration (e.g., collect one or more QoE measurements, as described below), and if the UE 120 moves outside of a validity area associated with the common QoE configuration, the UE 120 may determine that the common QoE configuration is invalid and thus cease to collect one or more QoE measurements.

As shown by reference number 515, the one or more network nodes 110 may transmit, and the UE 120 may receive, an MBS associated with the common QoE configuration. For example, the one or more network nodes 110 may transmit, and the UE 120 may receive, a broadcast communication service associated with the common QoE configuration. Accordingly, as shown by reference number 520, the UE 120 may collect at least one QoE measurement associated with the MBS based at least in part on the QoE configuration. In some aspects, the UE 120 may receive the MBS while in an RRC idle mode or an RRC inactive mode, as described. In such aspects, collecting the at least one QoE measurement associated with the MBS based at least in part on the QoE configuration may include collecting the at least one QoE measurement while in the RRC idle mode or the RRC inactive and then transmitting a QoE report associated with the one or more QoE measurements when the UE 120 is in an RRC connected mode. For example, as shown by reference number 525, the UE 120 may establish an RRC connection with the one or more network nodes 110 (e.g., the UE 120 may transition from an RRC idle mode or an RRC inactive mode to an RRC connected mode). Accordingly, the UE 120 may report any QoE measurements collected while the UE 120 was in the RRC idle mode or the RRC inactive mode to the one or more network nodes 110. More particularly, after establishing an RRC connection, and as shown by reference number 530, the UE 120 may transmit, and the one or more network nodes 110 may receive, a QoE report associated with the common QoE configuration and/or the one or more collected QoE measurements described in connection with reference number 520. In some aspects, the UE 120 may transmit the QoE report using an RRC message, such as the RRC message described in connection with step 6 in FIG. 4A.

Although the various aspects described in connection with FIG. 5A are described in connection with a common QoE configuration received via a broadcast message, aspects of the disclosure are not so limited. In some other aspects, the UE 120 may receive a dedicated QoE configuration received via an RRC message while the UE 120 is in an RRC connected mode or the like, as is shown in FIG. 5B.

More particularly, as shown by reference number 535, the one or more network nodes 110 may transmit, and the UE 120 may receive, configuration information. In some aspects, the UE 120 may receive the configuration information via one or more of RRC signaling, one or more MAC-CEs, and/or DCI, among other examples. In some aspects, the configuration information may include an indication of one or more configuration parameters (e.g., already known to the UE 120 and/or previously indicated by the one or more network nodes 110 or other network device) for selection by the UE 120, and/or explicit configuration information for the UE 120 to use to configure the UE 120, among other examples.

In some aspects, the configuration information may include one or more QoE configurations associated with an MBS, such as a broadcast communication service. Moreover, in the aspects depicted in FIG. 5B, the QoE configuration may be a dedicated QoE configuration received via an RRC message. For example, the dedicated QoE configuration may be received via an RRC reconfiguration message (such as the RRC reconfiguration message described in connection with step 3 in FIG. 4A), an RRC release message (such as an RRC message transmitted by the one or more network nodes 110, and received by the UE 120, when the UE 120 is transitioning to an RRC idle mode), or a similar RRC message. In some aspects, the dedicated QoE configuration may be received by the UE 120 via an RRC message while the UE 120 is in an RRC connected mode.

In some aspects, the dedicated QoE configuration may indicate certain parameters associated with one or more QMCs and/or one or more MBSs (e.g., one or more broadcast communication services) received by the UE 120, such as one or more MBSs received by the UE 120 when the UE 120 is in an RRC idle mode or an RRC inactive mode. For example, the dedicated QoE configuration may indicate at least one of a QoE configuration container associated with the dedicated QoE configuration, a service type associated with the dedicated QoE configuration (e.g., a particular MBS associated with the QoE configuration), or an identifier associated with the dedicated QoE configuration (e.g., a QoE reference associated with the QoE configuration), among other information. In some aspects, the dedicated QoE configuration may indicate a TMGI associated with the MBS being received by the UE 120 and/or associated with the dedicated QoE configuration.

In some aspects, the dedicated QoE configuration may be associated with a validity area. Accordingly, the dedicated QoE configuration may include an indication of the validity area. In some aspects, the validity area may be associated with a geographic area. Additionally, or alternatively, the validity area may be associated with one of a cell list, a tracking area list, a frequency list, or a similar list. Additionally, or alternatively, the dedicated QoE configuration may be associated with a validity timer. Accordingly, the dedicated QoE configuration may include an indication of the validity timer. The UE 120 may configure itself based at least in part on the configuration information. In some aspects, the UE 120 may be configured to perform one or more operations described herein based at least in part on the configuration information.

As shown by reference number 540, the UE 120 may enter an RRC idle mode or an RRC inactive mode. More particularly, the UE 120 may transition from an RRC connected mode (in which the UE 120 received the dedicated QoE configuration message) to the RRC idle mode or the RRC inactive mode. In some aspects, the UE 120 may receive one or more services while in the RRC idle mode or the RRC inactive mode, such as one or more MBSs (e.g., one or more broadcast communication services). In some aspects, the UE 120 may receive, from the one or more network nodes 110, an MBS associated with the dedicated QoE configuration after entering the RRC idle mode or the RRC inactive mode, which is described in more detail below in connection with reference number 550.

As shown by reference number 545, the UE 120 may determine a validity of the dedicated QoE configuration based at least in part on a validity timer associated with the dedicated QoE configuration, a validity area associated with the QoE configuration, or a similar parameter. For example, in some aspects, the QoE configuration may be associated with a validity area, as described above in connection with reference number 535. In such aspects, the UE 120 may determine whether the UE 120 is within the validity area. If the UE 120 has moved outside of the validity area, the UE 120 may determine that the dedicated QoE configuration is invalid. Put another way, in the operations described in connection with reference number 545, the UE 120 may determine that the dedicated QoE configuration is invalid based at least in part on the UE 120 moving outside of the validity area. In some aspects, based at least in part on determining that the dedicated QoE configuration is invalid, the UE 120 may attempt to receive another QoE configuration while in the RRC idle mode or the RRC inactive mode. For example, the UE 120 may attempt to receive a QoE configuration via a broadcast message, such as the common QoE configuration described in connection with FIG. 5A.

In some aspects, UE 120 may clear the dedicated QoE configuration based at least in part on determining that the dedicated QoE configuration is invalid, while, in some other aspects, the UE 120 may deactivate the dedicated QoE configuration based at least in part on determining that the dedicated QoE configuration is invalid. In aspects in which the UE 120 deactivates (rather than clears) the dedicated QoE configuration based at least in part on determining that the dedicated QoE configuration is invalid, the UE 120 may keep the QoE configuration (e.g., continue to store and/or maintain the QoE configuration at the application layer), but the UE 120 may cease collecting any QoE measurements associated with the deactivated QoE configuration. The UE 120 may later reactivate the dedicated QoE configuration if UE 120 re-enters the validity area. Put another way, upon re-entering the validity area, the UE 120 may reactivate the dedicated QoE configuration and resume collection of QoE measurements (which is described in more detail below in connection with reference number 555).

In some aspects, an access stratum layer of the UE 120 (e.g., the UE AS 425) may determine whether the UE 120 is within the validity area. In such aspects, the access stratum layer of the UE 120 may determine whether the UE 120 has moved outside of the validity area, and/or the access stratum layer of the UE 120 may indicate, to an application layer of the UE 120 (e.g., the UE APP 430), to stop collecting the at least one QoE measurement based at least in part on determining that the UE 120 has moved outside of the validity area. In some other aspects, an application layer of the UE 120 (e.g., the UE APP 430) may determine whether the UE 120 is within the validity area. In such aspects, the access stratum layer of the UE 120 may indicate, to the application layer of the UE 120, one or more parameters associated with determining whether the UE 120 is within the validity area. For example, the access stratum layer of the UE 120 may indicate, to the application layer of the UE 120, a validity area associated with the dedicated QoE configuration, a current cell associated with the UE 120, a current tracking area associated with the UE 120, a current frequency associated with the UE 120, and/or similar parameters. The application layer of the UE 120 may then determine whether the UE 120 is within the validity area based at least in part on the information indicated to the application layer of the UE 120 by the access stratum layer of the UE 120. For example, the application layer of the UE 120 may determine that the UE 120 has moved outside of the validity area based at least in part on one of: the current cell associated with the UE 120, the current tracking area associated with the UE 120, or the current frequency associated with the UE 120. In some other aspects, the dedicated QoE configuration may not be associated with a validity area. In such aspects, the UE 120 may apply the dedicated QoE configuration in an area associated with the MBS service indicated in a broadcast message. For example, the UE 120 may apply the dedicated QoE configuration for certain frequencies indicated by a system information block (SIB) associated with the MBS service, such as SIB21.

In some aspects, the dedicated QoE configuration may be associated with a validity timer, as described above. Accordingly, the operations shown in connection with reference number 545 may include determining whether the validity timer has expired. More particularly, the UE 120 may start a validity timer associated with the dedicated QoE configuration and/or determine whether the validity timer associated with the dedicated QoE configuration has expired. In some aspects, the UE 120 may begin a validity timer when the UE 120 enters one of an RRC idle mode or an RRC inactive mode, as described above in connection with reference number 540. In some other aspects, the UE 120 may begin the validity timer when the UE 120 receives the dedicated QoE configuration, as described above in connection with reference number 535. In some other aspects, the QoE configuration may indicate a start time for the validity timer (e.g., the QoE configuration may indicate a QoE session start time), and thus the UE 120 may begin the validity timer at the QoE session start time indicated by the dedicated QoE configuration.

As shown by reference number 550, the one or more network nodes 110 may transmit, and the UE 120 may receive, an MBS associated with the dedicated QoE configuration. For example, the one or more network nodes 110 may transmit, and the UE 120 may receive, a broadcast communication service associated with the dedicated QoE configuration. Accordingly, as shown by reference number 555, the UE 120 may collect at least one QoE measurement associated with the MBS based at least in part on the QoE configuration. As described above in connection with reference number 545, in some aspects, the dedicated QoE configuration may not indicate a validity area, and thus the UE 120 may apply the QoE configuration to an area indicated by and/or associated with the MBS. Thus, in some aspects, collecting the at least QoE measurement associated with the MBS may include applying the dedicated QoE configuration in an area indicated by a broadcast message associated with the MBS. For example, collecting the at least QoE measurement associated with the MBS may include applying the dedicated QoE configuration in one or more frequencies associated with the MBS indicated by a SIB message (e.g., SIB21).

In some aspects, the UE 120 may receive the MBS while in an RRC idle mode or an RRC inactive mode, as described. In such aspects, collecting the at least one QoE measurement associated with the MBS based at least in part on the QoE configuration may include collecting the at least one QoE measurement while in the RRC idle mode or the RRC inactive mode and transmitting a QoE report associated with the one or more QoE measurements while in an RRC connected mode. For example, as shown by reference number 560, the UE 120 may establish an RRC connection with the one or more network nodes 110 (e.g., the UE 120 may transition from an RRC idle mode or an RRC inactive mode to an RRC connected mode). Accordingly, the UE 120 may report any QoE measurements collected while the UE 120 was in the RRC idle mode or the RRC inactive mode to the one or more network nodes 110. More particularly, after establishing an RRC connection, and as shown by reference number 565, the UE 120 may transmit, and the one or more network nodes 110 may receive, a QoE report associated with the dedicated QoE configuration and/or the one or more collected QoE measurements described in connection with reference number 555. In some aspects, the UE 120 may transmit the QoE report using an RRC message, such as the RRC message described in connection with step 6 in FIG. 4A.

In some aspects, the UE 120 may determine whether to release the dedicated QoE configuration when the UE 120 re-enters the RRC connected mode. For example, the UE 120 may transmit, to the one or more network nodes 110, an indication of the stored dedicated QoE configuration based at least in part on the UE 120 entering the RRC connected mode. Additionally, or alternatively, the UE 120 may determine whether to release the dedicated QoE configuration based at least in part on a message received from the one or more network nodes 110. For example, as shown by reference number 570, in some aspects, the message received from the one or more network nodes 110 may include an indication that the UE 120 should release the dedicated QoE configuration. In some aspects, the indication that the UE 120 should release the dedicated QoE configuration is based at least in part on at least one of an indication of the dedicated QoE configuration transmitted by the UE 120 to the one or more network nodes 110, or assistance information transmitted by an OAM entity (e.g., the OAM 410) to the one or more network nodes 110. Additionally, or alternatively, the message received from the one or more network nodes 110 may include another QoE configuration. Put another way, when the one or more network nodes 110 transmit a dedicated QoE configuration to the UE 120, the UE 120 may release all stored QoE configurations, such as any previously received common QoE configurations (as described above in connection with FIG. 5A) and/or any previously received dedicated QoE configurations (as described above in connection with FIG. 5B).

Based at least in part on the one or more network nodes 110 configuring the UE 120 with a QoE configuration associated with an MBS, the UE 120 and/or the one or more network nodes 110 may conserve computing, power, network, and/or communication resources that may have otherwise been consumed by various QMC procedures. For example, based at least in part on the one or more network nodes 110 configuring the UE 120 with a QoE configuration associated with an MBS, the UE 120 may receive QoE configurations without frequent transitions between an RRC idle or RRC inactive mode and an RRC connected mode, and/or the UE 120 may collect one or more QoE measurements associated with an MBS received while the UE 120 is in an RRC idle mode or RRC inactive mode, which may conserve computing, power, network, and/or communication resources that may have otherwise been consumed to configure and collect QoE measurements using legacy QoE procedures.

As indicated above, FIGS. 5A-5B are provided as examples. Other examples may differ from what is described with respect to FIGS. 5A-5B.

FIG. 6 is a diagram illustrating an example process 600 performed, for example, by a UE, in accordance with the present disclosure. Example process 600 is an example where the UE (e.g., UE 120) performs operations associated with a QoE configuration for an MBS.

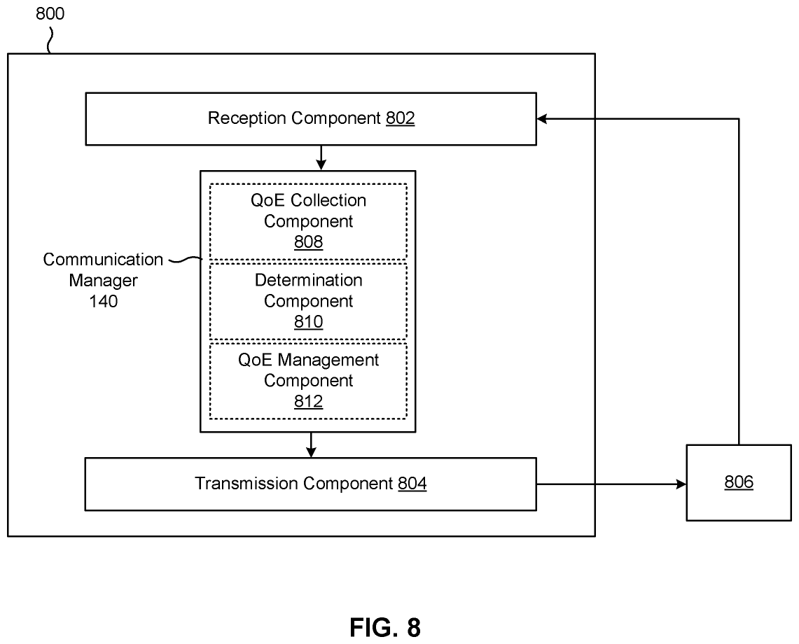

As shown in FIG. 6, in some aspects, process 600 may include receiving QoE configuration, wherein the QoE configuration is associated with an MBS (block 610). For example, the UE (e.g., using communication manager 140 and/or reception component 802, depicted in FIG. 8) may receive a QoE configuration, wherein the QoE configuration is associated with an MBS, as described above.

As further shown in FIG. 6, in some aspects, process 600 may include collecting at least one QoE measurement associated with the MBS based at least in part on the QoE configuration (block 620). For example, the UE (e.g., using communication manager 140 and/or QoE collection component 808, depicted in FIG. 8) may collect at least one QoE measurement associated with the MBS based at least in part on the QoE configuration, as described above.

Process 600 may include additional aspects, such as any single aspect or any combination of aspects described below and/or in connection with one or more other processes described elsewhere herein.

In a first aspect, the QoE configuration is a common QoE configuration received via a broadcast message.

In a second aspect, alone or in combination with the first aspect, the common QoE configuration indicates at least one of a QoE configuration container associated with the common QoE configuration, a service type associated with the common QoE configuration, or an identifier associated with the common QoE configuration.

In a third aspect, alone or in combination with one or more of the first and second aspects, the broadcast message is associated with one of a radio resource control message transmitted via a broadcast control channel or a system information message.

In a fourth aspect, alone or in combination with one or more of the first through third aspects, the common QoE configuration indicates a temporary mobile group identity associated with the MBS.

In a fifth aspect, alone or in combination with one or more of the first through fourth aspects, process 600 includes transmitting the common QoE configuration from an access stratum layer to an application layer.

In a sixth aspect, alone or in combination with one or more of the first through fifth aspects, transmitting the common QoE configuration from the access stratum layer to the application layer is based at least in part on the UE having no valid configuration associated with the common QoE configuration.

In a seventh aspect, alone or in combination with one or more of the first through sixth aspects, transmitting the common QoE configuration from the access stratum layer to the application layer is based at least in part on the UE receiving the MBS associated with the common QoE configuration.

In an eighth aspect, alone or in combination with one or more of the first through seventh aspects, process 600 includes starting a validity timer associated with the common QoE configuration.

In a ninth aspect, alone or in combination with one or more of the first through eighth aspects, process 600 includes determining that the common QoE configuration is invalid based at least in part on an expiration of the validity timer.

In a tenth aspect, alone or in combination with one or more of the first through ninth aspects, process 600 includes determining that the common QoE configuration is invalid based at least in part on the UE moving outside of a validity area associated with the common QoE configuration.

In an eleventh aspect, alone or in combination with one or more of the first through tenth aspects, the QoE configuration is a dedicated QoE configuration received via an RRC message.

In a twelfth aspect, alone or in combination with one or more of the first through eleventh aspects, the RRC message is one of an RRC reconfiguration message or an RRC release message.

In a thirteenth aspect, alone or in combination with one or more of the first through twelfth aspects, the dedicated QoE configuration is associated with a validity area.

In a fourteenth aspect, alone or in combination with one or more of the first through thirteenth aspects, the validity area is associated with one of a cell list, a tracking area list, or a frequency list.

In a fifteenth aspect, alone or in combination with one or more of the first through fourteenth aspects, process 600 includes determining that the dedicated QoE configuration is invalid based at least in part on the UE moving outside of the validity area.

In a sixteenth aspect, alone or in combination with one or more of the first through fifteenth aspects, process 600 includes clearing the dedicated QoE configuration based at least in part on determining that the dedicated QoE configuration is invalid.

In a seventeenth aspect, alone or in combination with one or more of the first through sixteenth aspects, process 600 includes deactivating the dedicated QoE configuration based at least in part on determining that the dedicated QoE configuration is invalid.

In an eighteenth aspect, alone or in combination with one or more of the first through seventeenth aspects, process 600 includes reactivating the dedicated QoE configuration based at least in part on the UE moving inside of the validity area.

In a nineteenth aspect, alone or in combination with one or more of the first through eighteenth aspects, process 600 includes determining, by an access stratum layer, that the UE has moved outside of the validity area, and indicating, to an application layer, to stop collecting the at least one QoE measurement based at least in part on determining that the UE has moved outside of the validity area.

In a twentieth aspect, alone or in combination with one or more of the first through nineteenth aspects, process 600 includes indicating, by an access stratum layer to an application layer, one of a current cell associated with the UE, a current tracking area associated with the UE, or a current frequency associated with the UE, and determining, by the application layer, that the UE has moved outside of the validity area based at least in part on the one of the current cell associated with the UE, the current tracking area associated with the UE, or the current frequency associated with the UE.

In a twenty-first aspect, alone or in combination with one or more of the first through twentieth aspects, process 600 includes applying the dedicated QoE configuration in an area indicated by a broadcast message associated with the MBS.

In a twenty-second aspect, alone or in combination with one or more of the first through twenty-first aspects, the area indicated by the broadcast message associated with the MBS is associated with one or more frequencies associated with the MBS indicated by a system information block message.

In a twenty-third aspect, alone or in combination with one or more of the first through twenty-second aspects, process 600 includes starting a validity timer associated with the dedicated QoE configuration based at least in part on one of: the UE entering one of an RRC idle mode or an RRC inactive mode, the UE receiving the dedicated QoE configuration, or a QoE session start time indicated by the dedicated QoE configuration.

In a twenty-fourth aspect, alone or in combination with one or more of the first through twenty-third aspects, process 600 includes releasing the dedicated QoE configuration based at least in part on a message received from a network node.

In a twenty-fifth aspect, alone or in combination with one or more of the first through twenty-fourth aspects, the message received from the network node includes an indication that the UE should release the dedicated QoE configuration.

In a twenty-sixth aspect, alone or in combination with one or more of the first through twenty-fifth aspects, the indication that the UE should release the dedicated QoE configuration is based at least in part on at least one of an indication of the dedicated QoE configuration transmitted by the UE to the network node, or assistance information transmitted by an operations, administration, and management entity to the network node.

In a twenty-seventh aspect, alone or in combination with one or more of the first through twenty-sixth aspects, the message received from the network node includes another QoE configuration.

In a twenty-eighth aspect, alone or in combination with one or more of the first through twenty-seventh aspects, process 600 includes transmitting an indication of the dedicated QoE configuration based at least in part on the UE entering an RRC connected mode.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with a QoE configuration for an MBS.

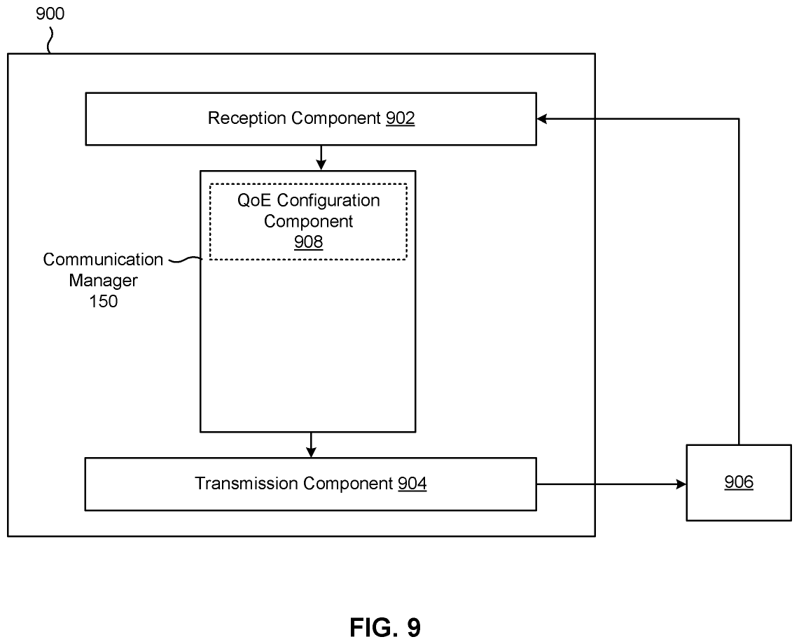

As shown in FIG. 7, in some aspects, process 700 may include transmitting, to a UE (e.g., UE 120), a QoE configuration, wherein the QoE configuration is associated with an MBS (block 710). For example, the network node (e.g., using communication manager 150, QoE configuration component 908, and/or transmission component 904, depicted in FIG. 9) may transmit, to a UE, a QoE configuration, wherein the QoE configuration is associated with an MBS, as described above.

As further shown in FIG. 7, in some aspects, process 700 may include receiving, from the UE, at least one QoE measurement report based at least in part on the QoE configuration (block 720). For example, the network node (e.g., using communication manager 150 and/or reception component 902, depicted in FIG. 9) may receive, from the UE, at least one QoE measurement report based at least in part on the QoE configuration, as described above.

Process 700 may include additional aspects, such as any single aspect or any combination of aspects described below and/or in connection with one or more other processes described elsewhere herein.

In a first aspect, the QoE configuration is a common QoE configuration transmitted via a broadcast message.

In a second aspect, alone or in combination with the first aspect, the common QoE configuration indicates at least one of a QoE configuration container associated with the common QoE configuration, a service type associated with the common QoE configuration, or an identifier associated with the common QoE configuration.

In a third aspect, alone or in combination with one or more of the first and second aspects, the broadcast message is associated with one of a radio resource control message transmitted via a broadcast control channel or a system information message.

In a fourth aspect, alone or in combination with one or more of the first through third aspects, the common QoE configuration indicates a temporary mobile group identity associated with the MBS.

In a fifth aspect, alone or in combination with one or more of the first through fourth aspects, the common QoE configuration is associated with a validity timer.

In a sixth aspect, alone or in combination with one or more of the first through fifth aspects, the QoE configuration is a dedicated QoE configuration transmitted via an RRC message.

In a seventh aspect, alone or in combination with one or more of the first through sixth aspects, the RRC message is one of an RRC reconfiguration message or an RRC release message.

In an eighth aspect, alone or in combination with one or more of the first through seventh aspects, the dedicated QoE configuration is associated with a validity area.

In a ninth aspect, alone or in combination with one or more of the first through eighth aspects, the validity area is associated with one of a cell list, a tracking area list, or a frequency list.

In a tenth aspect, alone or in combination with one or more of the first through ninth aspects, the dedicated QoE configuration is associated with an area indicated by a broadcast message associated with the MBS.

In an eleventh aspect, alone or in combination with one or more of the first through tenth aspects, the area indicated by the broadcast message associated with the MBS is associated with one or more frequencies associated with the MBS indicated by a system information block message.

In a twelfth aspect, alone or in combination with one or more of the first through eleventh aspects, the dedicated QoE configuration is associated with a validity timer.

In a thirteenth aspect, alone or in combination with one or more of the first through twelfth aspects, process 700 includes transmitting, to the UE, an indication that the UE should release the dedicated QoE configuration.

In a fourteenth aspect, alone or in combination with one or more of the first through thirteenth aspects, the indication that the UE should release the dedicated QoE configuration is based at least in part on at least one of an indication of the dedicated QoE configuration received by the network node from the UE, or assistance information received by the network node from an operations, administration, and management entity.

In a fifteenth aspect, alone or in combination with one or more of the first through fourteenth aspects, process 700 includes transmitting, to the UE, another QoE configuration.

In a sixteenth aspect, alone or in combination with one or more of the first through fifteenth aspects, process 700 includes receiving, from the UE, an indication of the dedicated QoE configuration based at least in part on the UE entering an RRC connected mode.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE 120, or a UE 120 may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE 120, a network node 110, or another wireless communication device) using the reception component 802 and the transmission component 804. As further shown, the apparatus 800 may include the communication manager 140. The communication manager 140 may include one or more of a QoE collection component 808, a determination component 810, or a QoE management component 812, among other examples.

In some aspects, the apparatus 800 may be configured to perform one or more operations described herein in connection with FIGS. 5A-5B. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE 120 described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE 120 described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE 120 described in connection with FIG. 2. In some aspects, the transmission component 804 may be co-located with the reception component 802 in a transceiver.

The reception component 802 may receive a QoE configuration, wherein the QoE configuration is associated with an MBS. The QoE collection component 808 may collect at least one QoE measurement associated with the MBS based at least in part on the QoE configuration.

The transmission component 804 and/or the QoE management component 812 may transmit the common QoE configuration from an access stratum layer to an application layer.

The determination component 810 may start a validity timer associated with the common QoE configuration.

The determination component 810 may determine that the common QoE configuration is invalid based at least in part on an expiration of the validity timer.

The determination component 810 may determine that the common QoE configuration is invalid based at least in part on the UE 120 moving outside of a validity area associated with the common QoE configuration.

The determination component 810 may determine that the dedicated QoE configuration is invalid based at least in part on the UE 120 moving outside of the validity area.

The QoE management component 812 may clear the dedicated QoE configuration based at least in part on determining that the dedicated QoE configuration is invalid.

The QoE management component 812 may deactivate the dedicated QoE configuration based at least in part on determining that the dedicated QoE configuration is invalid.

The QoE management component 812 may reactivate the dedicated QoE configuration based at least in part on the UE moving inside of the validity area.

The determination component 810 may determine that the UE has moved outside of the validity area.

The QoE management component 812 may indicate, to an application layer, to stop collecting the at least one QoE measurement based at least in part on determining that the UE has moved outside of the validity area.

The QoE management component 812 may indicate one of a current cell associated with the UE, a current tracking area associated with the UE, or a current frequency associated with the UE.

The determination component 810 may determine that the UE has moved outside of the validity area based at least in part on the one of the current cell associated with the UE, the current tracking area associated with the UE, or the current frequency associated with the UE.

The QoE management component 812 may apply the dedicated QoE configuration in an area indicated by a broadcast message associated with the MBS.

The determination component 810 may start a validity timer associated with the dedicated QoE configuration based at least in part on one of: the UE entering one of an RRC idle mode or an RRC inactive mode, the UE receiving the dedicated QoE configuration, or a QoE session start time indicated by the dedicated QoE configuration.

The QoE management component 812 may release the dedicated QoE configuration based at least in part on a message received from a network node.

The transmission component 804 may transmit an indication of the dedicated QoE configuration based at least in part on the UE entering an RRC connected mode.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node 110, or a network node 110 may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE 120, a network node 110, or another wireless communication device) using the reception component 902 and the transmission component 904. As further shown, the apparatus 900 may include the communication manager 150. The communication manager 150 may include a QoE configuration component 908, among other examples.

In some aspects, the apparatus 900 may be configured to perform one or more operations described herein in connection with FIG. 5A-5B. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node 110 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node 110 described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node 110 described in connection with FIG. 2. In some aspects, the transmission component 904 may be co-located with the reception component 902 in a transceiver.

The transmission component 904 and/or the QoE configuration component 908 may transmit, to a UE, a QoE configuration, wherein the QoE configuration is associated with an MBS. The reception component 902 may receive, from the UE, at least one QoE measurement report based at least in part on the QoE configuration.

The transmission component 904 and/or the QoE configuration component 908 may transmit, to the UE, an indication that the UE should release the dedicated QoE configuration.

The transmission component 904 and/or the QoE configuration component 908 may transmit, to the UE, another QoE configuration.

The reception component 902 may receive, from the UE, an indication of the dedicated QoE configuration based at least in part on the UE entering an RRC connected mode.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving a QoE configuration, wherein the QoE configuration is associated with an MBS; and collecting at least one QoE measurement associated with the MBS based at least in part on the QoE configuration.

Aspect 2: The method of Aspect 1, wherein the QoE configuration is a common QoE configuration received via a broadcast message.

Aspect 3: The method of Aspect 2, wherein the common QoE configuration indicates at least one of: a QoE configuration container associated with the common QoE configuration, a service type associated with the common QoE configuration, or an identifier associated with the common QoE configuration.

Aspect 4: The method of any of Aspects 2-3, wherein the broadcast message is associated with one of a radio resource control message transmitted via a broadcast control channel or a system information message.

Aspect 5: The method of any of Aspects 2-4, wherein the common QoE configuration indicates a temporary mobile group identity associated with the MBS.

Aspect 6: The method of any of Aspects 2-5, further comprising transmitting the common QoE configuration from an access stratum layer to an application layer.

Aspect 7: The method of Aspect 6, wherein transmitting the common QoE configuration from the access stratum layer to the application layer is based at least in part on the UE having no valid configuration associated with the common QoE configuration.

Aspect 8: The method of any of Aspects 6-7, wherein transmitting the common QoE configuration from the access stratum layer to the application layer is based at least in part on the UE receiving the MBS associated with the common QoE configuration.

Aspect 9: The method of any of Aspects 2-8, further comprising starting a validity timer associated with the common QoE configuration.

Aspect 10: The method of Aspect 9, further comprising determining that the common QoE configuration is invalid based at least in part on an expiration of the validity timer.

Aspect 11: The method of any of Aspects 2-10, further comprising determining that the common QoE configuration is invalid based at least in part on the UE moving outside of a validity area associated with the common QoE configuration.

Aspect 12: The method of Aspect 1, wherein the QoE configuration is a dedicated QoE configuration received via an RRC message.

Aspect 13: The method of Aspect 12, wherein the RRC message is one of an RRC reconfiguration message or an RRC release message.

Aspect 14: The method of any of Aspects 12-14, wherein the dedicated QoE configuration is associated with a validity area.

Aspect 15: The method of Aspect 14, wherein the validity area is associated with one of a cell list, a tracking area list, or a frequency list.

Aspect 16: The method of any of Aspects 14-15, further comprising determining that the dedicated QoE configuration is invalid based at least in part on the UE moving outside of the validity area.

Aspect 17: The method of Aspect 16, further comprising clearing the dedicated QoE configuration based at least in part on determining that the dedicated QoE configuration is invalid.

Aspect 18: The method of Aspect 16, further comprising deactivating the dedicated QoE configuration based at least in part on determining that the dedicated QoE configuration is invalid.

Aspect 19: The method of Aspect 18, further comprising reactivating the dedicated QoE configuration based at least in part on the UE moving inside of the validity area.

Aspect 20: The method of any of Aspects 16-19, further comprising: determining, by an access stratum layer, that the UE has moved outside of the validity area; and indicating, to an application layer, to stop collecting the at least one QoE measurement based at least in part on determining that the UE has moved outside of the validity area.

Aspect 21: The method of any of Aspects 16-20, further comprising: indicating, by an access stratum layer to an application layer, one of a current cell associated with the UE, a current tracking area associated with the UE, or a current frequency associated with the UE; and determining, by the application layer, that the UE has moved outside of the validity area based at least in part on the one of the current cell associated with the UE, the current tracking area associated with the UE, or the current frequency associated with the UE.

Aspect 22: The method of any of Aspects 12-21, further comprising applying the dedicated QoE configuration in an area indicated by a broadcast message associated with the MBS.

Aspect 23: The method of Aspect 22, wherein the area indicated by the broadcast message associated with the MBS is associated with one or more frequencies associated with the MBS indicated by a system information block message.

Aspect 24: The method of any of Aspects 12-23, further comprising starting a validity timer associated with the dedicated QoE configuration based at least in part on one of: the UE entering one of an RRC idle mode or an RRC inactive mode, the UE receiving the dedicated QoE configuration, or a QoE session start time indicated by the dedicated QoE configuration.

Aspect 25: The method of any of Aspects 12-24, further comprising releasing the dedicated QoE configuration based at least in part on a message received from a network node.

Aspect 26: The method of Aspect 25, wherein the message received from the network node includes an indication that the UE should release the dedicated QoE configuration.

Aspect 27: The method of Aspect 26, wherein the indication that the UE should release the dedicated QoE configuration is based at least in part on at least one of an indication of the dedicated QoE configuration transmitted by the UE to the network node, or assistance information transmitted by an operations, administration, and management entity to the network node.

Aspect 28: The method of any of Aspects 26-27, wherein the message received from the network node includes another QoE configuration.

Aspect 29: The method of any of Aspects 12-28, further comprising transmitting an indication of the dedicated QoE configuration based at least in part on the UE entering an RRC connected mode.

Aspect 30: A method of wireless communication performed by a network node, comprising: transmitting, to a UE, a QoE configuration, wherein the QoE configuration is associated with an MBS; and receiving, from the UE, at least one QoE measurement report based at least in part on the QoE configuration.

Aspect 31: The method of Aspect 30, wherein the QoE configuration is a common QoE configuration transmitted via a broadcast message.

Aspect 32: The method of Aspect 31, wherein the common QoE configuration indicates at least one of: a QoE configuration container associated with the common QoE configuration, a service type associated with the common QoE configuration, or an identifier associated with the common QoE configuration.

Aspect 33: The method of any of Aspects 31-32, wherein the broadcast message is associated with one of a radio resource control message transmitted via a broadcast control channel or a system information message.

Aspect 34: The method of any of Aspects 31-33, wherein the common QoE configuration indicates a temporary mobile group identity associated with the MBS.

Aspect 35: The method of any of Aspects 31-34, wherein the common QoE configuration is associated with a validity timer.

Aspect 36: The method of Aspect 30, wherein the QoE configuration is a dedicated QoE configuration transmitted via an RRC message.

Aspect 37: The method of Aspect 36, wherein the RRC message is one of an RRC reconfiguration message or an RRC release message.

Aspect 38: The method of any of Aspects 36-37, wherein the dedicated QoE configuration is associated with a validity area.

Aspect 39: The method of Aspect 38, wherein the validity area is associated with one of a cell list, a tracking area list, or a frequency list.

Aspect 40: The method of any of Aspects 36-39, wherein the dedicated QoE configuration is associated with an area indicated by a broadcast message associated with the MBS.

Aspect 41: The method of Aspect 40, wherein the area indicated by the broadcast message associated with the MBS is associated with one or more frequencies associated with the MBS indicated by a system information block message.

Aspect 42: The method of any of Aspects 36-41, wherein the dedicated QoE configuration is associated with a validity timer.

Aspect 43: The method of any of Aspects 36-42, further comprising transmitting, to the UE, an indication that the UE should release the dedicated QoE configuration.

Aspect 44: The method of Aspect 43, wherein the indication that the UE should release the dedicated QoE configuration is based at least in part on at least one of an indication of the dedicated QoE configuration received by the network node from the UE, or assistance information received by the network node from an operations, administration, and management entity.

Aspect 45: The method of any of Aspects 36-44, further comprising transmitting, to the UE, another QoE configuration.

Aspect 46: The method of any of Aspects 36-45, further comprising receiving, from the UE, an indication of the dedicated QoE configuration based at least in part on the UE entering an RRC connected mode.

Aspect 47: An apparatus for wireless communication at a device, comprising a processor; memory coupled with the processor; and instructions stored in the memory and executable by the processor to cause the apparatus to perform the method of one or more of Aspects 1-29.

Aspect 48: A device for wireless communication, comprising a memory and one or more processors coupled to the memory, the one or more processors configured to perform the method of one or more of Aspects 1-29.

Aspect 49: An apparatus for wireless communication, comprising at least one means for performing the method of one or more of Aspects 1-29.

Aspect 50: A non-transitory computer-readable medium storing code for wireless communication, the code comprising instructions executable by a processor to perform the method of one or more of Aspects 1-29.

Aspect 51: A non-transitory computer-readable medium storing a set of instructions for wireless communication, the set of instructions comprising one or more instructions that, when executed by one or more processors of a device, cause the device to perform the method of one or more of Aspects 1-29.

Aspect 52: An apparatus for wireless communication at a device, comprising a processor; memory coupled with the processor; and instructions stored in the memory and executable by the processor to cause the apparatus to perform the method of one or more of Aspects 30-46.

Aspect 53: A device for wireless communication, comprising a memory and one or more processors coupled to the memory, the one or more processors configured to perform the method of one or more of Aspects 30-46.

Aspect 54: An apparatus for wireless communication, comprising at least one means for performing the method of one or more of Aspects 30-46.

Aspect 55: A non-transitory computer-readable medium storing code for wireless communication, the code comprising instructions executable by a processor to perform the method of one or more of Aspects 30-46.

Aspect 56: A non-transitory computer-readable medium storing a set of instructions for wireless communication, the set of instructions comprising one or more instructions that, when executed by one or more processors of a device, cause the device to perform the method of one or more of Aspects 30-46.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of”' a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a quality of experience (QoE) configuration, wherein the QoE configuration is associated with a multicast or broadcast service (MBS); and
collect at least one QoE measurement associated with the MBS based at least in part on the QoE configuration.

2. The apparatus of claim 1, wherein the QoE configuration is a common QoE configuration received via a broadcast message.

3. The apparatus of claim 2, wherein the one or more processors are further configured to transmit the common QoE configuration from an access stratum layer to an application layer.

4. The apparatus of claim 3, wherein transmitting the common QoE configuration from the access stratum layer to the application layer is based at least in part on the UE having no valid configuration associated with the common QoE configuration.

5. The apparatus of claim 3, wherein transmitting the common QoE configuration from the access stratum layer to the application layer is based at least in part on the UE receiving the MBS associated with the common QoE configuration.

6. The apparatus of claim 2, wherein the one or more processors are further configured to start a validity timer associated with the common QoE configuration.

7. The apparatus of claim 6, wherein the one or more processors are further configured to determine that the common QoE configuration is invalid based at least in part on an expiration of the validity timer.

8. The apparatus of claim 2, wherein the one or more processors are further configured to determine that the common QoE configuration is invalid based at least in part on the UE moving outside of a validity area associated with the common QoE configuration.

9. The apparatus of claim 1, wherein the QoE configuration is a dedicated QoE configuration received via a radio resource control (RRC) message.

10. The apparatus of claim 9, wherein the dedicated QoE configuration is associated with a validity area.

11. The apparatus of claim 10, wherein the validity area is associated with one of a cell list, a tracking area list, or a frequency list.

12. The apparatus of claim 10, wherein the one or more processors are further configured to determine that the dedicated QoE configuration is invalid based at least in part on the UE moving outside of the validity area.

13. The apparatus of claim 12, wherein the one or more processors are further configured to clear the dedicated QoE configuration based at least in part on determining that the dedicated QoE configuration is invalid.

14. The apparatus of claim 12, wherein the one or more processors are further configured to deactivate the dedicated QoE configuration based at least in part on determining that the dedicated QoE configuration is invalid.

15. The apparatus of claim 14, wherein the one or more processors are further configured to reactivate the dedicated QoE configuration based at least in part on the UE moving inside of the validity area.

16. The apparatus of claim 12, wherein the one or more processors are further configured to:
determine, by an access stratum layer, that the UE has moved outside of the validity area; and
indicate, to an application layer, to stop collecting the at least one QoE measurement based at least in part determining that the UE has moved outside of the validity area.

17. The apparatus of claim 12, wherein the one or more processors are further configured to:
indicate, by an access stratum layer to an application layer, one of a current cell associated with the UE, a current tracking area associated with the UE, or a current frequency associated with the UE; and
determine, by the application layer, that the UE has moved outside of the validity area based at least in part on the one of the current cell associated with the UE, the current tracking area associated with the UE, or the current frequency associated with the UE.

18. The apparatus of claim 9, wherein the one or more processors are further configured to apply the dedicated QoE configuration in an area indicated by a broadcast message associated with the MBS.

19. The apparatus of claim 18, wherein the area indicated by the broadcast message associated with the MBS is associated with one or more frequencies associated with the MBS indicated by a system information block message.

20. The apparatus of claim 9, wherein the one or more processors are further configured to release the dedicated QoE configuration based at least in part on a message received from a network node.

21. The apparatus of claim 20, wherein the message received from the network node includes another QoE configuration.

22. The apparatus of claim 9, wherein the one or more processors are further configured to transmit an indication of the dedicated QoE configuration based at least in part on the UE entering an RRC connected mode.

23. An apparatus for wireless communication at a network node, comprising:
a memory; and
one or more processors, coupled to the memory, configured to:
transmit, to a user equipment (UE), a quality of experience (QoE) configuration, wherein the QoE configuration is associated with a multicast or broadcast service (MBS); and
receive, from the UE, at least one QoE measurement report based at least in part on the QoE configuration.

24. The apparatus of claim 23, wherein the QoE configuration is a common QoE configuration transmitted via a broadcast message.

25. The apparatus of claim 23, wherein the QoE configuration is a dedicated QoE configuration transmitted via a radio resource control (RRC) message.

26. The apparatus of claim 25, wherein the RRC message is one of an RRC reconfiguration message or an RRC release message.

27. A method of wireless communication performed by a user equipment (UE), comprising:
receiving a quality of experience (QoE) configuration, wherein the QoE configuration is associated with a multicast or broadcast service (MBS); and
collecting at least one QoE measurement associated with the MBS based at least in part on the QoE configuration.

28. The method of claim 27, wherein the QoE configuration is a common QoE configuration received via a broadcast message.

29. A method of wireless communication performed by a network node, comprising:
transmitting, to a user equipment (UE), a quality of experience (QoE) configuration, wherein the QoE configuration is associated with a multicast or broadcast service (MBS); and
receiving, from the UE, at least one QoE measurement report based at least in part on the QoE configuration.

30. The method of claim 29, wherein the QoE configuration is a dedicated QoE configuration transmitted via a radio resource control (RRC) message.
